(19) United States
(12) Patent Application Publication
(10) Pub. No.: US 2024/0381415 A1
(43) Pub. Date: Nov. 14, 2024

(54) ALIGNED TWT OPERATION IN WIRELESS NETWORKS

(71) Applicant: Samsung Electronics Co., Ltd., Suwon-si (KR)

(72) Inventors: Rubayet Shafin, Allen, TX (US); Boon Loong Ng, Plano, TX (US)

(21) Appl. No.: 18/649,800

(22) Filed: Apr. 29, 2024

Related U.S. Application Data
(60) Provisional application No. 63/465,741, filed on May 11, 2023.

(51) Int. Cl. H04W 74/04; H04W 74/08; H04W 76/40

(52) U.S. Cl. CPC H04W 74/04; H04W 52/0216; H04W 74/0866; H04W 76/40; H04W 84/12

(57) ABSTRACT

A first STA affiliated with the non-AP MLD and operating on the first link intends to establish on the first link a first broadcast TWT schedule that is aligned with a second broadcast TWT schedule on the second link on which a second STA affiliated with the non-AP MLD is operating. The first STA may decode a beacon frame or a probe response frame transmitted from a first AP affiliated with the AP MLD and operating on the first link to identify where there is a broadcast TWT schedule on the first link that is aligned with the second broadcast TWT schedule on the second link. The first STA can identify the presence of the aligned schedule on the first link by checking a broadcast TWT parameter set field included within a broadcast TWT element included in the beacon frame or the probe response frame.

### CROSS-REFERENCE TO RELATED APPLICATIONS

This application claims the benefit of priority from U.S. Provisional Application No. 63/465,741, entitled “POWER SAVING OPERATION FOR ALIGNED TWT SCHEDULE,” filed May 11, 2023, which is incorporated herein by reference in its entirety.

### TECHNICAL FIELD

This disclosure relates generally to a wireless communication system, and more particularly to, for example, but not limited to, power saving in wireless communication systems.

### BACKGROUND

Wireless local area network (WLAN) technology has evolved toward increasing data rates and continues its growth in various markets such as home, enterprise and hotspots over the years since the late 1990s. WLAN allows devices to access the internet in the 2.4 GHz, 5 GHz, 6 GHz or 60 GHz frequency bands. WLANs are based on the Institute of Electrical and Electronic Engineers (IEEE) 802.11 standards. IEEE 802.11 family of standards aims to increase speed and reliability and to extend the operating range of wireless networks.

WLAN devices are increasingly required to support a variety of delay-sensitive applications or real-time applications such as augmented reality (AR), robotics, artificial intelligence (AI), cloud computing, and unmanned vehicles. To implement extremely low latency and extremely high throughput required by such applications, multi-link operation (MLO) has been suggested for the WLAN. The WLAN is formed within a limited area such as a home, school, apartment, or office building by WLAN devices. Each WLAN device may have one or more stations (STAs) such as the access point (AP) STA and the non-access-point (non-AP) STA.

The MLO may enable a non-AP multi-link device (MLD) to set up multiple links with an AP MLD. Each of multiple links may enable channel access and frame exchanges between the non-AP MLD and the AP MLD independently, which may reduce latency and increase throughput.

The description set forth in the background section should not be assumed to be prior art merely because it is set forth in the background section. The background section may describe aspects or embodiments of the present disclosure.

### SUMMARY

An aspect of the present disclosure provides a non-access point (AP) multi-link device (MLD) associated with an AP MLD in a wireless network. The non-AP MLD comprises at least two stations (STAs) and a processor coupled to the at least two STAs. Each STA is affiliated with the non-AP MLD and the processor is configured to cause receiving, by a first STA affiliated with the non-AP MLD from a first AP affiliated with the AP MLD via a first link between the first STA and the first AP, a first broadcast frame that advertises a first broadcast target wake time (TWT) schedule and indicates whether the first broadcast TWT schedule is an aligned schedule. The processor is configured to cause determining, by the first STA, that the first broadcast TWT schedule is aligned with one or more broadcast TWT schedules on one or more of other links of the AP MLD based on the first broadcast frame. The processor is configured to cause transmitting, by the first STA to the first AP via the first link, a TWT request to join the first broadcast TWT schedule. The processor is configured to cause receiving, by the first STA from the first AP via the first link, a TWT response indicating acceptance of the TWT request.

In some embodiments, the processor is further configured to cause: receiving, by a second STA affiliated with the non-AP MLD from a second AP affiliated with the AP MLD via a second link between the second STA and the second AP, a second broadcast frame advertising a second broadcast TWT schedule; determining, by the second STA, that there is a second broadcast TWT schedule advertised on the second link that is aligned with the first broadcast TWT schedule on the first link, based on the second broadcast frame; transmitting, by the second STA to the second AP via the second link, a TWT request to join the second broadcast TWT schedule; and receiving, by the second STA from the second AP via the second link, a TWT response indicating acceptance of the TWT request to join the second broadcast TWT schedule.

In some embodiments, the processor is further configured to cause: waking up from doze state to receive, by a third STA affiliated with the non-AP MLD from a third AP affiliated with the AP MLD via a third link between the third STA and the third AP, a third broadcast frame; determining, by the third STA, that there is no broadcast TWT schedule advertised on the third link that is aligned with the first broadcast TWT schedule on the first link based on the third broadcast frame; and going back to the doze state after receiving the third broadcast frame.

In some embodiments, the first broadcast frame includes a first TWT element, and the determining comprises checking one or more TWT parameters included in the first TWT element.

In some embodiments, the second broadcast frame includes a second TWT element, and the determining comprises checking one or more TWT parameters included in the second TWT element.

In some embodiments, the third broadcast frame includes a third TWT element, and the determining comprises checking one or more TWT parameters included in the third TWT element.

In some embodiments, the first STA is in doze state, and the receiving comprises waking up to receive the first broadcast frame.

In some embodiments, the second STA is in doze state, and the receiving comprises waking up to receive the second broadcast frame.

In some embodiments, a broadcast TWT identifier of the first broadcast TWT schedule is identical to a broadcast TWT identifier of the second broadcast TWT schedule.

An aspect of the present disclosure provides an access point (AP) multi-link device (MLD) associated with a non-AP MLD in a wireless network. The AP MLD comprises at least two APs and a processor coupled to the at least two APs. Each AP is affiliated with the AP MLD and the processor configured to cause: transmitting, by a first AP affiliated with the AP MLD to a first STA affiliated with the non-AP MLD via a first link between the first AP and the first STA, a first broadcast frame that advertises a first broadcast target wake time (TWT) schedule and indicates that the first broadcast TWT schedule is an aligned schedule; receiving, by the first AP from the first STA via the first link, a TWT request to join the first broadcast TWT schedule; and transmitting, by the first AP to the first STA via the first link, a TWT response indicating acceptance of the TWT request.

In some embodiments, the processor is further configured to cause: transmitting, by a second AP affiliated with the AP MLD to a second STA affiliated with the non-AP MLD via a second link between the second AP and the second STA, a second broadcast frame that advertises a second broadcast TWT schedule and indicates that there is a second broadcast TWT schedule advertised on the second link that is aligned with the first broadcast TWT schedule on the first link; receiving, by the second AP from the second STA via the second link, a TWT request to join the second broadcast TWT schedule; and transmitting, by the second AP to the second STA via the second link, a TWT response indicating acceptance of the TWT request to join the second broadcast TWT schedule.

In some embodiments, the processor is further configured to cause transmitting, by a third AP affiliated with the AP MLD to a third STA affiliated with the non-AP MLD via a third link between the third AP and the third STA, a third broadcast frame indicating that there is no broadcast TWT schedule advertised on the third link that is aligned with the first broadcast TWT schedule on the first link.

In some embodiments, the first broadcast frame includes a first TWT element, and one or more TWT parameters included in the first TWT element indicate that the first broadcast TWT schedule is aligned with one or more broadcast TWT schedules on one or more of other links of the AP MLD.

In some embodiments, the second broadcast frame includes a second TWT element, and one or more TWT parameters included in the second TWT element indicate that the second broadcast TWT schedule is aligned with the first broadcast TWT schedule on the first link.

In some embodiments, the third broadcast frame includes a third TWT element, and one or more TWT parameters included in the third TWT element indicate that there is no broadcast TWT schedule advertised on the third link that is aligned with the first broadcast TWT schedule on the first link.

In some embodiments, a broadcast TWT identifier of the first broadcast TWT schedule is identical to a broadcast TWT identifier of the second broadcast TWT schedule.

An aspect of the present disclosure provides a computer-implemented method for facilitating wireless communication. The method comprises: receiving, by a first station (STA) affiliated with a non-access point (AP) multi-link device (MLD) from a first AP affiliated with an AP MLD associated with the non-AP MLD on a first link between the first STA and the first AP, a first broadcast frame advertising a first broadcast target wake time (TWT) schedule on the first link; determining that the first broadcast TWT schedule is aligned with one or more broadcast TWT schedules on one or more of other links of the AP MLD based on the first broadcast frame; transmitting, by the first STA to the first AP on the first link, a TWT request to join the first broadcast TWT schedule on the first link; and receiving, by the first STA from the first AP on the first link, a TWT response to accept the TWT request.

In some embodiments, the method further comprises: receiving, by a second STA affiliated with the non-AP MLD from the second AP affiliated with the AP MLD on a second link between the second STA and the second AP, a second broadcast frame advertising a second broadcast TWT schedule on the second link; determining, by the second STA, that the second broadcast TWT schedule is aligned with the first broadcast TWT schedule on the first link based on the second broadcast frame; transmitting, by the second STA to the second AP on the second link, a TWT request to join the second broadcast TWT schedule on the second link; and receiving, by the second STA from the second AP on the second link, a TWT response indicating acceptance of the TWT request to join the second broadcast TWT schedule on the second link.

In some embodiments, the method further comprises: waking up from doze state to receive, by a third STA affiliated with the non-AP MLD from a third AP affiliated with the AP MLD on a third link between the third STA and the third AP, a third broadcast frame advertising a broadcast TWT schedule; determining, by the third STA, that there is no broadcasting TWT schedule advertised on the third link that is aligned with the first broadcast TWT schedule based on the third broadcast frame; and going back to the doze state after receiving the third broadcast frame.

In some embodiments, a broadcast TWT identifier of the first broadcast TWT schedule is identical to a broadcast TWT identifier of the second broadcast TWT schedule.

### BRIEF DESCRIPTION OF THE DRAWINGS

FIG. 1 shows an example of a wireless network in accordance with an embodiment.

FIG. 2A shows an example of AP in accordance with an embodiment.

FIG. 2B shows an example of STA in accordance with an embodiment.

FIG. 3 shows an example of multi-link communication operation in accordance with an embodiment.

FIG. 4 shows an example of individual TWT operation in accordance with an embodiment.

FIG. 5 shows an example of broadcast TWT operation in accordance with an embodiment.

FIG. 6 shows an example of a broadcast TWT operation in accordance with an embodiment.

FIG. 7 shows an example of an individual TWT negotiation between an AP MLD and a non-AP MLD in accordance with an embodiment.

FIG. 8 shows an example of an aligned TWT schedule in accordance with an embodiment.

FIG. 9 shows an example format of the TWT element in accordance with an embodiment.

FIG. 10 shows an example process for identifying the presence of an aligned TWT schedule in accordance with an embodiment.

FIG. 11 shows another example process for identifying the presence of aligned TWT schedule in accordance with an embodiment.

FIG. 12 shows another example process for identifying the presence of an aligned TWT schedule in accordance with an embodiment.

FIG. 13 shows an example of aligned broadcast TWT schedule operation in accordance with an embodiment.

FIGS. 14A and 14B show other examples of aligned broadcast TWT schedule operation in accordance with an embodiment.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below, in connection with the appended drawings, is intended as a description of various implementations and is not intended to represent the only implementations in which the subject technology may be practiced. Rather, the detailed description includes specific details for the purpose of providing a thorough understanding of the inventive subject matter. As those skilled in the art would realize, the described implementations may be modified in various ways, all without departing from the scope of the present disclosure. Accordingly, the drawings and description are to be regarded as illustrative in nature and not restrictive. Like reference numerals designate like elements.

The following description is directed to certain implementations for the purpose of describing the innovative aspects of this disclosure. However, a person having ordinary skill in the art will readily recognize that the teachings herein can be applied in a multitude of different ways. The examples in this disclosure are based on WLAN communication according to the Institute of Electrical and Electronics Engineers (IEEE) 802.11 standard, including IEEE 802.11be standard and any future amendments to the IEEE 802.11 standard. However, the described embodiments may be implemented in any device, system or network that is capable of transmitting and receiving radio frequency (RF) signals according to the IEEE 802.11 standard, the Bluetooth standard, Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), 5G NR (New Radio), AMPS, or other known signals that are used to communicate within a wireless, cellular or internet of things (IoT) network, such as a system utilizing 3G, 4G, 5G, 6G, or further implementations thereof, technology.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

Multi-link operation (MLO) is a key feature that is currently being developed by the standards body for next generation extremely high throughput (EHT) Wi-Fi systems in IEEE 802.11be. The Wi-Fi devices that support MLO are referred to as multi-link devices (MLD). With MLO, it is possible for a non-AP MLD to discover, authenticate, associate, and set up multiple links with an AP MLD. Channel access and frame exchange is possible on each link between the AP MLD and non-AP MLD.

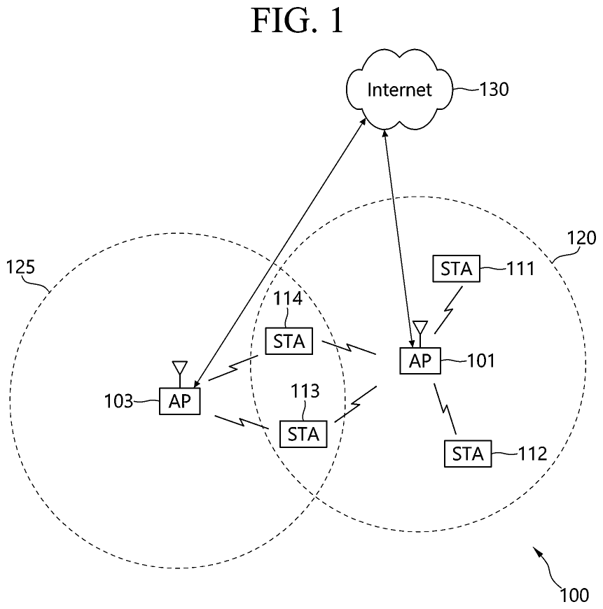

FIG. 1 shows an example of a wireless network 100 in accordance with an embodiment. The embodiment of the wireless network 100 shown in FIG. 1 is for illustrative purposes only. Other embodiments of the wireless network 100 could be used without departing from the scope of this disclosure.

As shown in FIG. 1, the wireless network 100 may include a plurality of wireless communication devices. Each wireless communication device may include one or more stations (STAs). The STA may be a logical entity that is a singly addressable instance of a medium access control (MAC) layer and a physical (PHY) layer interface to the wireless medium. The STA may be classified into an access point (AP) STA and a non-access point (non-AP) STA. The AP STA may be an entity that provides access to the distribution system service via the wireless medium for associated STAs. The non-AP STA may be a STA that is not contained within an AP-STA. For the sake of simplicity of description, an AP STA may be referred to as an AP and a non-AP STA may be referred to as a STA. In the example of FIG. 1, APs 101 and 103 are wireless communication devices, each of which may include one or more AP STAs. In such embodiments, APs 101 and 103 may be AP multi-link device (MLD). Similarly, STAs 111-114 are wireless communication devices, each of which may include one or more non-AP STAs. In such embodiments, STAs 111-114 may be non-AP MLD.

The APs 101 and 103 communicate with at least one network 130, such as the Internet, a proprietary Internet Protocol (IP) network, or other data network. The AP 101 provides wireless access to the network 130 for a plurality of stations (STAs) 111-114 with a coverage are 120 of the AP 101. The APs 101 and 103 may communicate with each other and with the STAs using Wi-Fi or other WLAN communication techniques.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

In FIG. 1, dotted lines show the approximate extents of the coverage area 120 and 125 of APs 101 and 103, which are shown as approximately circular for the purposes of illustration and explanation. It should be clearly understood that coverage areas associated with APs, such as the coverage areas 120 and 125, may have other shapes, including irregular shapes, depending on the configuration of the APs.

As described in more detail below, one or more of the APs may include circuitry and/or programming for management of MU-MIMO and OFDMA channel sounding in WLANs. Although FIG. 1 shows one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101 and 103 could communicate directly with the network 130 and provides STAs with direct wireless broadband access to the network 130. Further, the APs 101 and/or 103 could provide access to other or additional external networks, such as external telephone networks or other types of data networks.

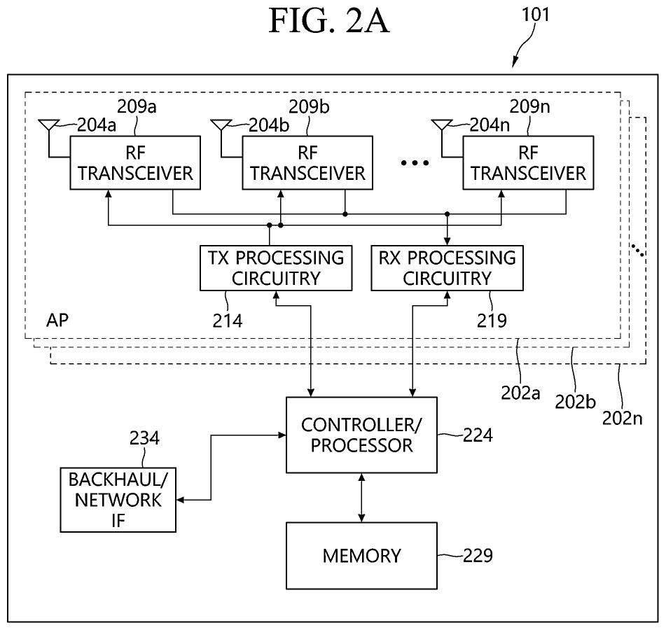

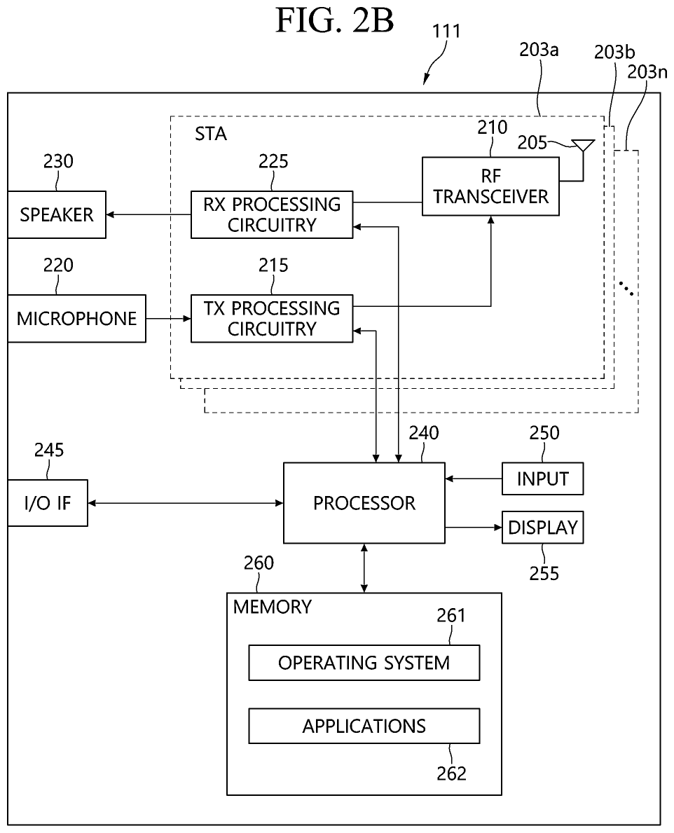

FIG. 2A shows an example of AP 101 in accordance with an embodiment. The embodiment of the AP 101 shown in FIG. 2A is for illustrative purposes, and the AP 103 of FIG. 1 could have the same or similar configuration. However, APs come in a wide range of configurations, and FIG. 2A does not limit the scope of this disclosure to any particular implementation of an AP.

As shown in FIG. 2A, the AP 101 may include multiple antennas 204a-204n, multiple radio frequency (RF) transceivers 209a-209n, transmit (TX) processing circuitry 214, and receive (RX) processing circuitry 219. The AP 101 also may include a controller/processor 224, a memory 229, and a backhaul or network interface 234. The RF transceivers 209a-209n receive, from the antennas 204a-204n, incoming RF signals, such as signals transmitted by STAs in the network 100. The RF transceivers 209a-209n down-convert the incoming RF signals to generate intermediate (IF) or baseband signals. The IF or baseband signals are sent to the RX processing circuitry 219, which generates processed baseband signals by filtering, decoding, and/or digitizing the baseband or IF signals. The RX processing circuitry 219 transmits the processed baseband signals to the controller/processor 224 for further processing.

The TX processing circuitry 214 receives analog or digital data (such as voice data, web data, e-mail, or interactive video game data) from the controller/processor 224. The TX processing circuitry 214 encodes, multiplexes, and/or digitizes the outgoing baseband data to generate processed baseband or IF signals. The RF transceivers 209a-209n receive the outgoing processed baseband or IF signals from the TX processing circuitry 214 and up-converts the baseband or IF signals to RF signals that are transmitted via the antennas 204a-204n.

The controller/processor 224 can include one or more processors or other processing devices that control the overall operation of the AP 101. For example, the controller/processor 224 could control the reception of uplink signals and the transmission of downlink signals by the RF transceivers 209a-209n, the RX processing circuitry 219, and the TX processing circuitry 214 in accordance with well-known principles. The controller/processor 224 could support additional functions as well, such as more advanced wireless communication functions. For instance, the controller/processor 224 could support beam forming or directional routing operations in which outgoing signals from multiple antennas 204a-204n are weighted differently to effectively steer the outgoing signals in a desired direction. The controller/processor 224 could also support OFDMA operations in which outgoing signals are assigned to different subsets of subcarriers for different recipients (e.g., different STAs 111-114). Any of a wide variety of other functions could be supported in the AP 101 by the controller/processor 224 including a combination of DL MU-MIMO and OFDMA in the same transmit opportunity. In some embodiments, the controller/processor 224 may include at least one microprocessor or microcontroller. The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP 101 to communicate with other devices or systems over a backhaul connection or over a network. The interface 234 could support communications over any suitable wired or wireless connection(s). For example, the interface 234 could allow the AP 101 to communicate over a wired or wireless local area network or over a wired or wireless connection to a larger network (such as the Internet). The interface 234 may include any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

As described in more detail below, the AP 101 may include circuitry and/or programming for management of channel sounding procedures in WLANs. Although FIG. 2A illustrates one example of AP 101, various changes may be made to FIG. 2A. For example, the AP 101 could include any number of each component shown in FIG. 2A. As a particular example, an AP could include a number of interfaces 234, and the controller/processor 224 could support routing functions to route data between different network addresses. As another example, while shown as including a single instance of TX processing circuitry 214 and a single instance of RX processing circuitry 219, the AP 101 could include multiple instances of each (such as one per RF transceiver). Alternatively, only one antenna and RF transceiver path may be included, such as in legacy APs. Also, various components in FIG. 2A could be combined, further subdivided, or omitted and additional components could be added according to particular needs.

As shown in FIG. 2A, in some embodiment, the AP 101 may be an AP MLD that includes multiple APs 202a-202n. Each AP 202a-202n is affiliated with the AP MLD 101 and includes multiple antennas 204a-204n, multiple radio frequency (RF) transceivers 209a-209n, transmit (TX) processing circuitry 214, and receive (RX) processing circuitry 219. Each APs 202a-202n may independently communicate with the controller/processor 224 and other components of the AP MLD 101. FIG. 2A shows that each AP 202a-202n has separate multiple antennas, but each AP 202a-202n can share multiple antennas 204a-204n without needing separate multiple antennas. Each AP 202a-202n may represent a physical (PHY) layer and a lower media access control (MAC) layer.

FIG. 2B shows an example of STA 111 in accordance with an embodiment. The embodiment of the STA 111 shown in FIG. 2B is for illustrative purposes, and the STAs 111-114 of FIG. 1 could have the same or similar configuration. However, STAs come in a wide variety of configurations, and FIG. 2B does not limit the scope of this disclosure to any particular implementation of a STA.

As shown in FIG. 2B, the STA 111 may include antenna(s) 205, a RF transceiver 210, TX processing circuitry 215, a microphone 220, and RX processing circuitry 225. The STA 111 also may include a speaker 230, a controller/processor 240, an input/output (I/O) interface (IF) 245, a touchscreen 250, a display 255, and a memory 260. The memory 260 may include an operating system (OS) 261 and one or more applications 262.

The RF transceiver 210 receives, from the antenna(s) 205, an incoming RF signal transmitted by an AP of the network 100. The RF transceiver 210 down-converts the incoming RF signal to generate an IF or baseband signal. The IF or baseband signal is sent to the RX processing circuitry 225, which generates a processed baseband signal by filtering, decoding, and/or digitizing the baseband or IF signal. The RX processing circuitry 225 transmits the processed baseband signal to the speaker 230 (such as for voice data) or to the controller/processor 240 for further processing (such as for web browsing data).

The TX processing circuitry 215 receives analog or digital voice data from the microphone 220 or other outgoing baseband data (such as web data, e-mail, or interactive video game data) from the controller/processor 240. The TX processing circuitry 215 encodes, multiplexes, and/or digitizes the outgoing baseband data to generate a processed baseband or IF signal. The RF transceiver 210 receives the outgoing processed baseband or IF signal from the TX processing circuitry 215 and up-converts the baseband or IF signal to an RF signal that is transmitted via the antenna(s) 205.

The controller/processor 240 can include one or more processors and execute the basic OS program 261 stored in the memory 260 in order to control the overall operation of the STA 111. In one such operation, the controller/processor 240 controls the reception of downlink signals and the transmission of uplink signals by the RF transceiver 210, the RX processing circuitry 225, and the TX processing circuitry 215 in accordance with well-known principles. The controller/processor 240 can also include processing circuitry configured to provide management of channel sounding procedures in WLANs. In some embodiments, the controller/processor 240 may include at least one microprocessor or microcontroller.

The controller/processor 240 is also capable of executing other processes and programs resident in the memory 260, such as operations for management of channel sounding procedures in WLANs. The controller/processor 240 can move data into or out of the memory 260 as required by an executing process. In some embodiments, the controller/processor 240 is configured to execute a plurality of applications 262, such as applications for channel sounding, including feedback computation based on a received null data packet announcement (NDPA) and null data packet (NDP) and transmitting the beamforming feedback report in response to a trigger frame (TF). The controller/processor 240 can operate the plurality of applications 262 based on the OS program 261 or in response to a signal received from an AP. The controller/processor 240 is also coupled to the I/O interface 245, which provides STA 111 with the ability to connect to other devices such as laptop computers and handheld computers. The I/O interface 245 is the communication path between these accessories and the main controller/processor 240.

The controller/processor 240 is also coupled to the input 250 (such as touchscreen) and the display 255. The operator of the STA 111 can use the input 250 to enter data into the STA 111. The display 255 may be a liquid crystal display, light emitting diode display, or other display capable of rendering text and/or at least limited graphics, such as from web sites. The memory 260 is coupled to the controller/processor 240. Part of the memory 260 could include a random access memory (RAM), and another part of the memory 260 could include a Flash memory or other read-only memory (ROM).

Although FIG. 2B shows one example of STA 111, various changes may be made to FIG. 2B. For example, various components in FIG. 2B could be combined, further subdivided, or omitted and additional components could be added according to particular needs. In particular examples, the STA 111 may include any number of antenna(s) 205 for MIMO communication with an AP 101. In another example, the STA 111 may not include voice communication or the controller/processor 240 could be divided into multiple processors, such as one or more central processing units (CPUs) and one or more graphics processing units (GPUs). Also, while FIG. 2B illustrates the STA 111 configured as a mobile telephone or smartphone, STAs could be configured to operate as other types of mobile or stationary devices.

As shown in FIG. 2B, in some embodiment, the STA 111 may be a non-AP MLD that includes multiple STAs 203a-203n. Each STA 203a-203n is affiliated with the non-AP MLD 111 and includes an antenna(s) 205, a RF transceiver 210, TX processing circuitry 215, and RX processing circuitry 225. Each STAs 203a-203n may independently communicate with the controller/processor 240 and other components of the non-AP MLD 111. FIG. 2B shows that each STA 203a-203n has a separate antenna, but each STA 203a-203n can share the antenna 205 without needing separate antennas. Each STA 203a-203n may represent a physical (PHY) layer and a lower media access control (MAC) layer.

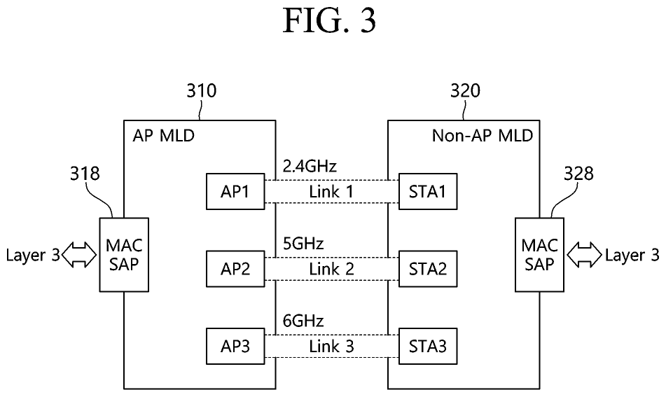

FIG. 3 shows an example of multi-link communication operation in accordance with an embodiment. The multi-link communication operation may be usable in IEEE 802.11be standard and any future amendments to IEEE 802.11 standard. In FIG. 3, an AP MLD 310 may be the wireless communication device 101 and 103 in FIG. 1 and a non-AP MLD 220 may be one of the wireless communication devices 111-114 in FIG. 1.

As shown in FIG. 3, the AP MLD 310 may include a plurality of affiliated APs, for example, including AP 1, AP 2, and AP 3. Each affiliated AP may include a PHY interface to wireless medium (Link 1, Link 2, or Link 3). The AP MLD 310 may include a single MAC service access point (SAP) 318 through which the affiliated APs of the AP MLD 310 communicate with a higher layer (Layer 3 or network layer). Each affiliated AP of the AP MLD 310 may have a MAC address (lower MAC address) different from any other affiliated APs of the AP MLD 310. The AP MLD 310 may have a MLD MAC address (upper MAC address) and the affiliated APs share the single MAC SAP 318 to Layer 3. Thus, the affiliated APs share a single IP address, and Layer 3 recognizes the AP MLD 310 by assigning the single IP address.

The non-AP MLD 320 may include a plurality of affiliated STAs, for example, including STA 1, STA 2, and STA 3. Each affiliated STA may include a PHY interface to the wireless medium (Link 1, Link 2, or Link 3). The non-AP MLD 320 may include a single MAC SAP 328 through which the affiliated STAs of the non-AP MLD 320 communicate with a higher layer (Layer 3 or network layer). Each affiliated STA of the non-AP MLD 320 may have a MAC address (lower MAC address) different from any other affiliated STAs of the non-AP MLD 320. The non-AP MLD 320 may have a MLD MAC address (upper MAC address) and the affiliated STAs share the single MAC SAP 328 to Layer 3. Thus, the affiliated STAs share a single IP address, and Layer 3 recognizes the non-AP MLD 320 by assigning the single IP address.

The AP MLD 310 and the non-AP MLD 320 may set up multiple links between their affiliate APs and STAs. In this example, the AP 1 and the STA 1 may set up Link 1 which operates in 2.4 GHz band. Similarly, the AP 2 and the STA 2 may set up Link 2 which operates in 5 GHz band, and the AP 3 and the STA 3 may set up Link 3 which operates in 6 GHz band. Each link may enable channel access and frame exchange between the AP MLD 310 and the non-AP MLD 320 independently, which may increase date throughput and reduce latency. Upon associating with an AP MLD on a set of links (setup links), each non-AP device is assigned a unique association identifier (AID).

The following documents are hereby incorporated by reference in their entirety into the present disclosure as if fully set forth herein: i) IEEE 802.11-2020, “Wireless LAN Medium Access Control (MAC) and Physical Layer (PHY) Specifications” and ii) IEEE P802.11be/D3.0, “Wireless LAN Medium Access Control (MAC) and Physical Layer (PHY) Specifications.”

Target wake time (TWT) operation is a feature of power management in WLAN networks. The TWT operation has been introduced in IEEE 802.11ah standard and later modified in IEEE 802.11ax standard. The TWT operation enables an AP to manage activity in the basic service set (BSS) to minimize contention between STAs and reduce the required wake times for STAs during the TWT operation. It can be achieved by allocating STAs to operate at non-overlapping times or frequencies and perform the frame exchange sequences in pre-scheduled service periods. In the TWT operation, a STA can wake up at pre-scheduled times that have been negotiated with an AP or another STA in the BSS. The STA does not need to be aware of TWT parameter values of other STAs within the BSS or of STAs in other BSSs. The STA does not need to be aware that a TWT service period (SP) is used to exchange frames with other STAs. Frames transmitted during a TWT SP can employ any PPDU (physical layer protocol data unit) format supported by the pair of STAs that have established the corresponding TWT agreement or TWT schedule, including, but not limited to, HE MU (high efficiency multi-user) PPDU, HE TB (high efficiency trigger based) PPDU.

IEEE 802.11 standard describes two types of TWT operations: individual TWT operation and broadcast TWT operation. In the individual TWT operation, an individual TWT agreement can be established between two STAs or between a STA and an AP. The negotiation for the individual TWT operation may occur between two STAs or between a STA and an AP on an individual basis. An AP may have TWT agreements with multiple STAs. Any changes in the TWT agreement between the AP and one STA do not affect the TWT agreement between the AP and other STAs.

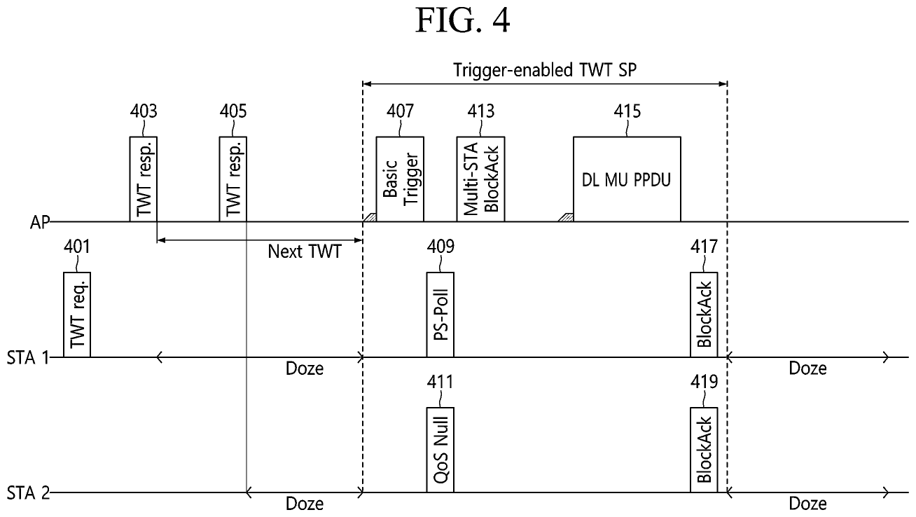

FIG. 4 shows an example of individual TWT operation in accordance with an embodiment. The operation depicted in FIG. 4 is for illustration purposes and does not limit the scope of this disclosure to any particular implementations.

In the example of FIG. 4, STA 1 and STA 2 are TWT requesting STAs and AP is a TWT responding STA. STA 1 sends a TWT request 401 to AP to setup a trigger-enabled TWT agreement. The AP accepts the TWT request 401 with STA 1 and confirms the acceptance in TWT response 403 sent to STA 1. Subsequently, the AP sends an unsolicited TWT response 405 to STA 2 to set up a trigger-enabled TWT agreement with STA 2. Both these TWT agreements are set up as announced TWTs. During the trigger-enabled TWT SP, the AP sends a basic trigger frame 407 to the TWT requesting STAs (STA 1 and STA 2) which may indicate that they are awake during the TWT SP. STA 1 indicates that it is awake by sending a PS (power save)-Poll frame 409, and STA 2 indicates that it is awake by sending QoS (quality of service) Null frame 411 in response to the Basic Trigger frame 407. Subsequently, the AP sends a Multi-STA Block Ack 413 frame and DL MU (downlink multi-user) PPDU 415 to both STA 1 and STA 2. Afterward, STA 1 and STA 2 respectively send BlockAck frames 417 and 419 to the AP, and then go to doze state.

On the other hand, the broadcast TWT operates in a membership-based approach. In broadcast TWT operation, an AP can set up a shared TWT session for a group of STAs. The AP is typically the controller of the broadcast TWT schedule. The non-AP STAs in the BSS can request membership in the broadcast TWT schedule, or the AP can send unsolicited response to a STA to make the STA a member of the broadcast TWT schedule that the AP maintains in the BSS. The AP may advertise and maintain multiple broadcast TWT schedules in the BSS. When a change is made to any broadcast TWT schedules in the BSS, it may affect all or some of STAs that are members of the corresponding broadcast TWT schedule.

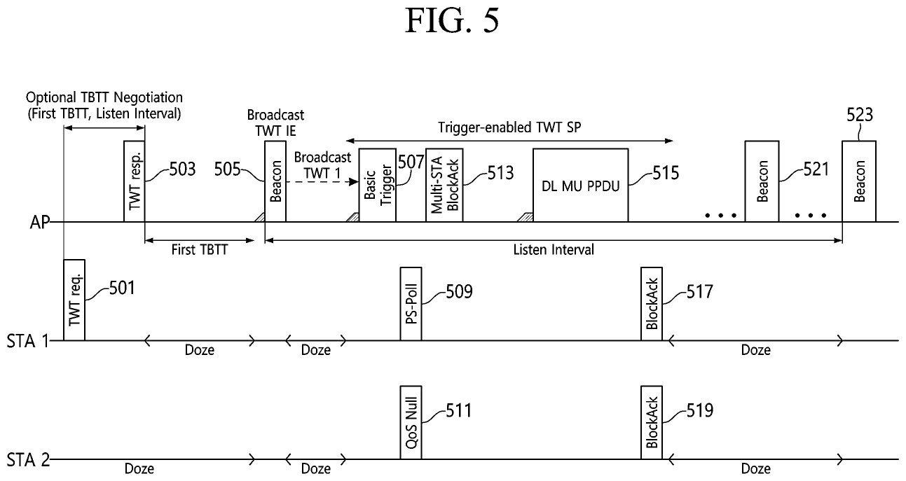

FIG. 5 shows an example of broadcast TWT operation in accordance with an embodiment. The operation depicted in FIG. 5 is for illustration purposes and does not limit the scope of this disclosure to any particular implementations.

In FIG. 5, STA 1 and STA 2 are TWT scheduled STAs and AP is a TWT scheduling AP. In the example of FIG. 5, STA 1 and AP may have optional TBTT (target beacon transmission time) negotiation by exchanging TWT request frame 501 and TWT response frame 503. After the first TBTT, the AP sends a beacon frame 505 including a broadcast TWT element that indicates a broadcast TWT SP. During the TWT SP, the AP may send a trigger frame or downlink buffer-able units (BUs) to the TWT scheduled STAs (STA 1 and STA 2). STA 1 and STA 2 wake to receive the beacon frame 505 to determine the broadcast TWT. During the trigger-enabled TWT SP, the AP sends a basic trigger frame 507 to STA 1 and STA 2 which indicate that they are awake during the TWT SP. STA 1 indicates that it is awake by sending a PS-Poll frame 509, while STA 2 indicates that it is awake by sending a QoS Null frame 511 in response to the basic trigger frame 507. STA 1 and STA 2 receive their DL BUs in a subsequent frame exchange (e.g., Multi-STA BlockAck 513, DL MU PPDU 515, and BlockAck 517 and 519) with the AP and go to doze state out of the TWT SP. After the TWT SP, the AP sends beacon frames 521 and 523 periodically to STA 1 and STA 2. As illustrated, the AP can advertise/announce and maintain multiple broadcast TWT schedules in the BSS. When a change is made to any of the broadcast TWT schedules, it may affect all STAs that are members of the particular TWT schedule.

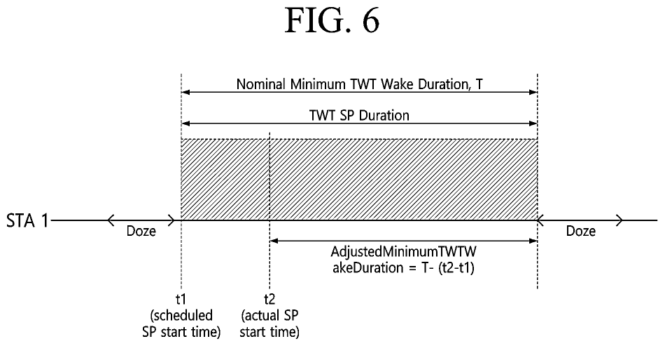

FIG. 6 shows an example of a broadcast TWT operation in accordance with an embodiment. The operation depicted in FIG. 6 is for illustration purposes and does not limit the scope of this disclosure to any particular implementations.

In FIG. 6, STA 1 establishes a broadcast TWT schedule with STA 1. STA 1 is a TWT scheduled STA and there is an AP (not shown in FIG. 6) which is an associated TWT scheduling AP. In this disclosure, the TWT scheduled STA is a STA that follows the broadcast TWT schedules provided in a broadcast TWT element. The TWT scheduling AP is an AP that schedules broadcast TWTs and provides these broadcast TWT schedules in a broadcast TWT element.

In a broadcast TWT parameter set field of the broadcast TWT element, t1 is the value of the target wake time indicated in the target wake time field in the broadcast TWT parameter set field of the broadcast TWT element. Therefore, t1 is the ideal time for STA 1 to initiate a frame exchange sequence with AP 1. Starting from t1, the time duration that STA 1 is required to remain awake may be the value of nominal wake time duration (T) indicated in the nominal minimum TWT wake duration field in the broadcast TWT parameter set field. In some implementations, STA 1 may not be able to initiate the frame exchange sequence with AP 1 at the nominal SP start time t1, and the actual SP start time may be much later. In the example of FIG. 6, the actual SP start time is indicated as t2. Consequently, due to the delayed actual SP start time, the minimum wake duration for STA 1 may be adjusted, denoted as ‘AdjustedMinimumTWTWakeDuration=T−(t2−t1)).’

In the individual TWT agreement between multi-link devices (MLDs) that supports multi-link operation, a STA affiliated with an MLD, which is a TWT requesting STA, may indicate the links that are requested for setting up TWT agreements in the link ID bitmap subfield of a TWT element in the TWT request frame. When only one link is indicated in the link ID bitmap subfield, a single TWT agreement is requested for the STA affiliated with the MLD, which operates on the indicated link. The target wake time field of the TWT element may be in reference to the TSF (timing synchronization function) time of the link indicated in the TWT element. Subsequently, a TWT responding STA affiliated with a peer MLD, which receives the TWT request, may respond with a TWT response that indicates the links in a link ID bitmap subfield of a TWT element. The links in the TWT element of the TWT response may be the same as the links indicated in the TWT element of the TWT request.

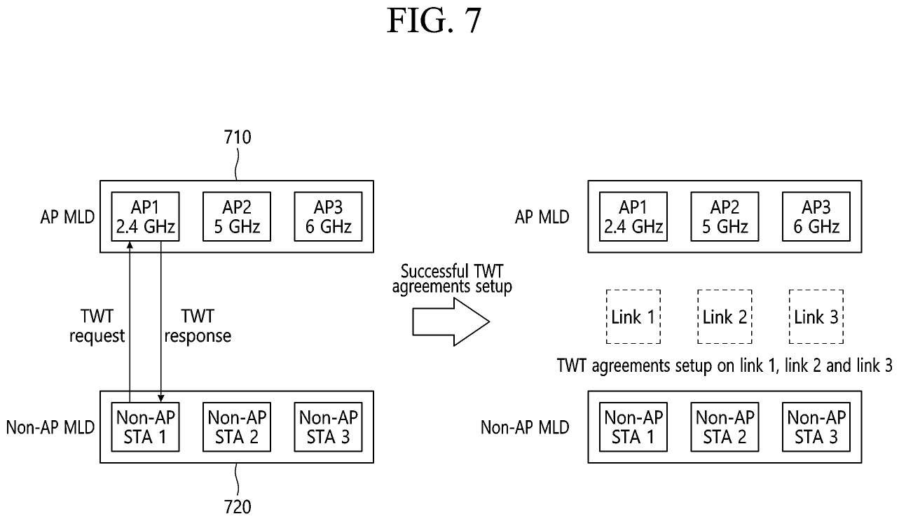

FIG. 7 shows an example of an individual TWT negotiation between an AP MLD and a non-AP MLD in accordance with an embodiment. The operation depicted in FIG. 7 is for illustration purposes and does not limit the scope of this disclosure to any particular implementations.

In FIG. 7, AP 1, AP 2, and AP 3 are affiliated with AP MLD 710. Non-AP STA 1, Non-AP STA 2, and Non-AP STA 3 are affiliated with Non-AP MLD 720. In some implementations, AP 1 and non-AP STA 1 operate on 2.4 GHz band, AP 2 and non-AP STA 2 operate on 5 GHz band, and AP 3 and non-AP STA 3 operate on 6 GHz band. The non-AP STA 1 affiliated with the non-AP MLD 720 may send three TWT elements in a TWT request to the AP 1 affiliated with the AP MLD 710 for three TWT agreements. The three TWT elements indicate the links of AP 1, AP 2, and AP 3, respectively, with the request of three TWT agreements to be set up on three links. The three TWT agreements may have different TWT parameters, such as target wake up time and a value of demand TWT in the TWT setup command field. Subsequently, the AP 1 sends three TWT elements in a TWT response to the non-AP STA 1. The three TWT elements indicate the links of AP 1, AP 2, and AP 3, respectively, and have different TWT parameters, such as a value of accept TWT in the TWT setup command field. After successful TWT agreement setup on the three links, there exist three TWT SPs with different TWT parameter on the three links.

Restricted TWT (R-TWT) operation is another important feature for the next generation WLAN. The R-TWT operation provides better support for latency sensitive applications. For instance, traffic in real time applications has stringent requirements in terms of latency and its jitter along with certain reliability constraint. Such traffic may be referred to as latency sensitive traffic in this disclosure. The R-TWT operation may offer a protected service period (SP) for R-TWT member STAs by sending Quiet elements to non-member STAs in the BSS in the R-TWT schedule. In some implementations, a quiet interval of the Quiet element overlaps with the initial portion of the R-TWT SP. Therefore, it may provide greater channel access opportunities to R-TWT member STAs than non-member STAs, thereby improving the flow of latency sensitive traffic.

Latency-sensitive traffic may be bursty and periodic. When there is a traffic identifier (TID) associated with latency-sensitive traffic, a non-AP MLD may prefer to map the TID associated with latency-sensitive traffic to more than one or all setup links. For the TID associated with latency-sensitive traffic, STAs affiliated with the non-AP MLD may wake up at the same time on multiple links so that the latency-sensitive traffic with the TID can flow over the multiple links, thereby increasing the channel access opportunity for the latency-sensitive traffic. In this scenario, the non-AP MLD may benefit from becoming a member of TWT schedules that are aligned across multiple links. However, the broadcast TWT schedules established across the multiple links may not possibly be aligned across multiple links by TWT scheduling APs affiliated with the AP MLD in current WLAN systems. Accordingly, the AP MLD may need to align or synchronize a specific set of TWT schedules across multiple links and indicate which TWT schedules are aligned across multiple links during broadcast TWT announcement phase.

In some embodiments, an aligned schedule is a broadcast TWT schedule that is offered across multiple links by APs affiliated with an AP MLD where the target wake time (TWT) of the schedule on the multiple setup links are aligned and TWT parameters for the aligned schedules on multiple links are the same as each other.

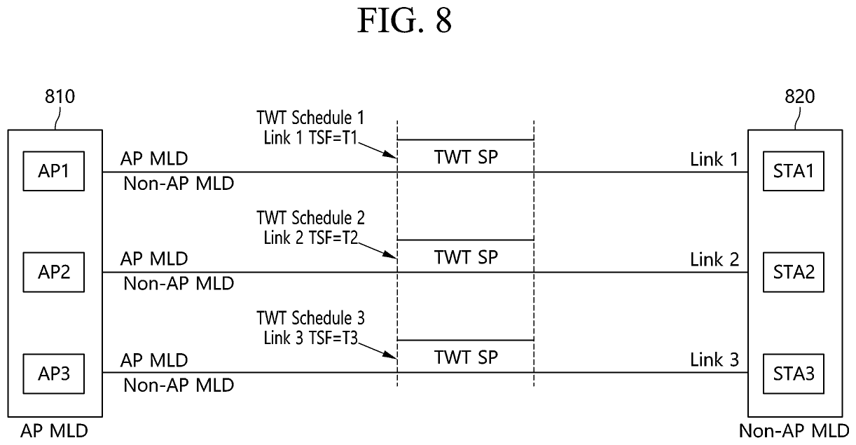

FIG. 8 shows an example of an aligned TWT schedule in accordance with an embodiment. This example may be applicable to IEEE 802.11be standard and any future amendments to IEEE 802.11 standard. The AP MLD 810 and the non-AP MLD 820 may be examples of the AP MLD 310 and the non-AP MLD 320 illustrated in FIG. 3, respectively. The AP MLD 810 may include three affiliated APs (AP 1, AP 2, and AP 3), and the non-AP MLD 820 may include three affiliated STAs (STA 1, STA 2, and STA 3). AP 1 and STA 1 may operate on Link 1, AP 2 and STA 2 may operate on Link 2, and AP 3 and STA 3 may operate on Link 3. For example, Link 1, Link 2, and Link 3 may use 2.4 GHz frequency band, 5 GHz frequency band, and 6 GHz frequency band, respectively.

Referring to FIG. 8, a broadcast TWT schedule 1 is established on Link 1 between AP 1 and STA 1. Similarly, a broadcast TWT schedule 2 is established on Link 2 between AP 2 and STA 2, a broadcast TWT schedule 3 is established on Link 3 between AP 3 and STA 3. In FIG. 8, broadcast TWT schedules 1-3 are aligned with each other on their respective links. In some implementations, the timing synchronization function (TSF) values T1, T2, and T3 on Link 1, Link 2, and Link 3 indicate the start times of TWT service periods (SPs) for broadcast TWT schedules 1-3 on their respective links. These values may be aligned with each other as shown in FIG. 8.

In FIG. 8, the AP MLD 810 may establish three broadcast TWT schedules across multiple links (Link 1, Link 2, and Link 3). However, since TWT scheduled STAs affiliated with the non-AP MLD 820 operate independently on their respective links, the TWT scheduled STAs operating on their respective links may be not aware of which TWT schedules are aligned. Accordingly, if a schedule is marked or indicated as “aligned” schedule during the advertisement or announcement phase, the TWT scheduled STAs affiliated with the non-AP MLD may gain advantage by joining the aligned schedule across multiple links, thereby enhancing the performance of their latency-sensitive applications.

The concept of the aligned TWT schedule and related procedure has been discussed for the next generation WLAN including IEEE 802.11be standard task group. However, it is not clear how the non-AP STAs operating on different links of the non-AP MLD become aware of the aligned TWT schedule advertised by the APs on the corresponding links. Additionally, a mechanism by which non-AP STAs manage their power-saving operation along with the aligned TWT schedule needs to be defined.

The present disclosure provides a mechanism and procedure to determine the presence of an aligned TWT schedule in the multi-link operation (MLO). Additionally, the present disclosure provides a power saving mechanism for non-AP STAs in conjunction with aligned TWT management.

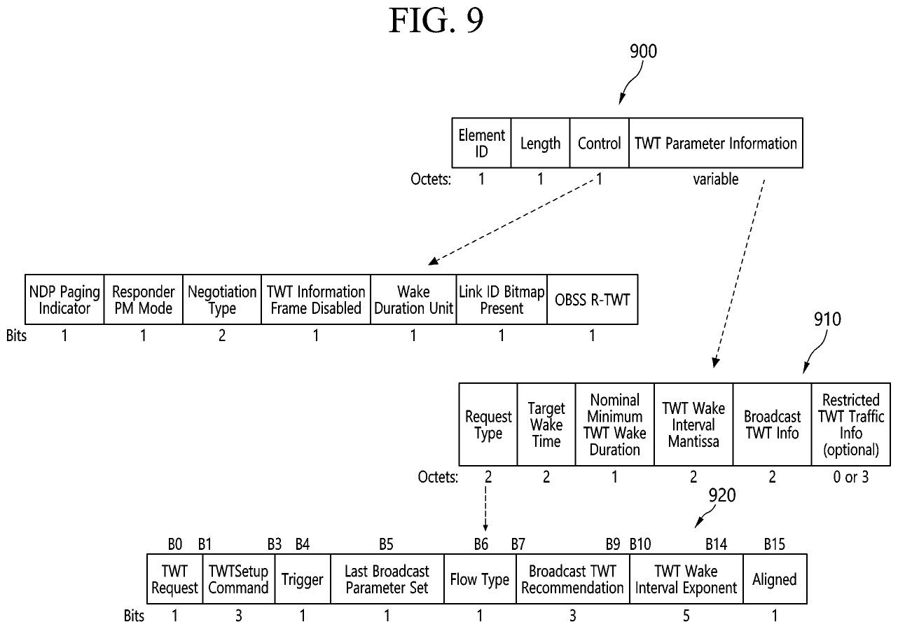

FIG. 9 shows an example format of the TWT element in accordance with an embodiment.

In FIG. 9, the TWT element 900 may include an Element identifier (ID) field, a length field, a Control field, and a TWT Parameter Information field. The Element ID field may include information to identify the TWT element 900. The Length field may indicate a length of the TWT element 900.

The Control field may include a null data PPDU (physical layer protocol data unit) (NDP) Paging Indicator subfield, a Responder power management (PM) Mode subfield, a Negotiation Type subfield, a TWT Information Frame Disabled subfield, a Wake Duration Unit subfield, a Link ID Bitmap Present subfield, and an OBSS R-TWT subfield. The NDP Paging Indicator subfield may indicate whether an NDP paging field is present or not in an Individual TWT Parameter Set field. The Responder PM Mode subfield may indicate the power management mode, such as active mode and power save (PS) mode. The negotiation Type subfield may indicate whether the information included in the TWT element is for the negotiation of parameters of broadcast or individual TWT or Wake TBTT (target beacon transmission time) interval. The MSB (most significant bit) of the Negotiation Type subfield is the Broadcast field which indicates if one or more Broadcast TWT Parameter Sets are contained in the TWT element. The TWT Information Frame Disabled subfield may indicate whether the reception of TWT information frame is disabled by the STA. The Wake Duration Unit subfield may indicate the unit of the Nominal Minimum TWT Wake Duration subfield in the Broadcast TWT Parameter Set field 520. The Link ID Bitmap Present subfield may indicate the presence of the Link ID Bitmap field in the Individual TWT Parameter Set field. The OBSS R-TWT subfield may indicate whether the R-TWT schedules corresponding to the Broadcast TWT Parameter Set fields in the TWT element are the R-TWT schedule of the neighboring BSS. When the OBSS R-TWT subfield is set to ‘1’, it may indicate that the R-TWT schedules in the TWT element are the R-TWT schedule of the neighboring BSS. Otherwise, it indicates that there is no neighboring BSS's R-TWT schedule in the TWT element.

The TWT Parameter information field may include one or more Broadcast TWT Parameter Set fields 910. The Broadcast TWT Parameter Set field 910 may include a Request Type field, a Target Wake Time field, a Nominal Minimum TWT Wake Duration field, a TWT Wake Interval Mantissa field, a Broadcast TWT Info (Information) field, and an optional Restricted TWT traffic Info field. The Request Type field includes information about the TWT element. The Target Wake Time field may include an unsigned integer corresponding to a TSF (time synchronization function) time for the TWT scheduled STA to wake up. The Target Wake Time field may indicate the start time of the TWT service period (SP) on the corresponding link. The Nominal Minimum TWT Wake Duration field may indicate the minimum amount of time that the TWT scheduled STA is expected to be awake to compete the frame exchanges for the period of TWT wake interval. The TWT wake interval is the average time that the TWT scheduled STA expects to elapse between successive TWT SPs. The TWT Wake Interval Mantissa field may indicate the value of the mantissa of the TWT wake interval value. The Broadcast TWT Info field may include information related to the broadcast TWT, such as a Broadcast TWT ID and a Broadcast TWT Persistence.

In some embodiments, the Request Type field 920 of the Broadcast TWT Parameter Set field 910 can be used to indicate the presence of the aligned TWT schedule. Referring to FIG. 9, the Request Type field 920 includes a TWT Request subfield, a TWT Setup Command subfield, a Trigger subfield, a Last Broadcast Parameter Set subfield, a Flow Type subfield, a Broadcast TWT Recommendation subfield, a TWT Wake Interval Exponent subfield, and an Aligned subfield. The Request Type field 940 may be usable for Broadcast TWT operation.

The TWT Request subfield may indicate if the transmitting STA is a TWT scheduling AP (or STA) or a TWT scheduled STA (or AP). The TWT Setup Command subfield may indicate the type of TWT command, such as Request TWT, Suggest TWT, Demand TWT, TWT Grouping, Accept TWT, Alternate TWT, Dictate TWT and Reject TWT. The Trigger subfield may indicate whether the TWT SP indicated by the TWT element includes triggering frames. The Last Broadcast Parameter Set subfield may indicate whether another Broadcast TWT Parameter Set field follows this Broadcast TWT Parameter Set field. The Flow Type subfield may indicate the type of interaction, for example, an announced TWT or an unannounced TWT between the TWT scheduled STA and the TWT scheduling AP at TWT. The Broadcast TWT Recommendation subfield may indicate recommendations on the types of frames that are transmitted by TWT scheduled STAs and TWT scheduling AP during the broadcast TWT SP. For instance, the types of frames may be PS-Poll and QoS Null frames, management frames, control response frames, or No constraints on the frame. The TWT Wake Interval Exponent subfield may indicate the value of the exponent of the TWT wake interval value. The Aligned subfield may indicate whether one or more of other links of the AP MLD have broadcast TWT schedules that are aligned with the corresponding schedule. More specifically, if the subfield is set to 1, it may indicate that there are one or more schedules on other links that are aligned with the TWT schedule identified by the Broadcast TWT Parameter Set field. Otherwise, the schedule is no such schedule on the other links.

In some embodiments, a non-AP MLD is associated with an AP MLD and operating on two links, a first link and a second link. A first STA affiliated with the non-AP MLD and operating on the first link intends to establish on the first link a first broadcast TWT schedule that is aligned with a second broadcast TWT schedule on the second link on which a second STA affiliated with the non-AP MLD is operating. The first STA may decode a beacon frame or a probe response frame transmitted from a first AP affiliated with the AP MLD and operating on the first link to identify where there is a broadcast TWT schedule on the first link that is aligned with the second broadcast TWT schedule on the second link. The first STA can identify the presence of the aligned schedule on the first link by checking a broadcast TWT parameter set field included within a broadcast TWT element included in the beacon frame or the probe response frame. The broadcast TWT parameter set field indicates whether the corresponding TWT schedule is an aligned schedule and a target wake time of the TWT schedule is aligned with a target wake time of one or more other broadcast TWT schedules advertised on one or more other links of the same AP MLD.

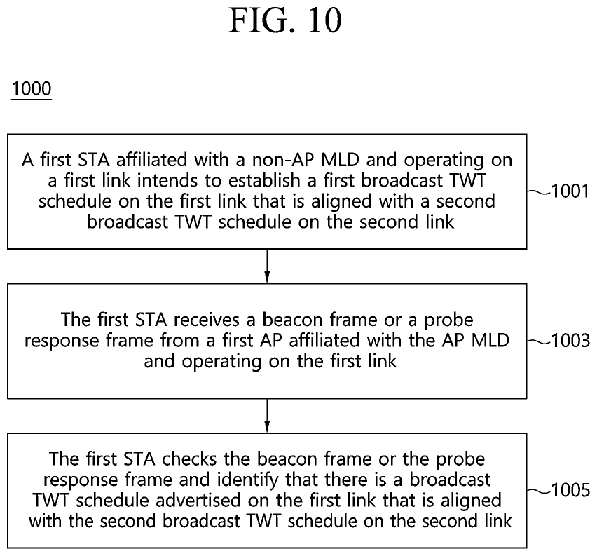

FIG. 10 shows an example process for identifying the presence of an aligned TWT schedule in accordance with an embodiment. For explanatory and illustration purposes, the example process 1000 may be performed by the STA 1 depicted in FIGS. 3 and 8. Although one or more operations are described or shown in particular sequential order, in other embodiments the operations may be rearranged in a different order, which may include performance of multiple operations in at least partially overlapping time periods.

The process 1000 may begin in operation 1001. In operation 1001, a first STA affiliated with a non-AP MLD and operating on a first link intends to establish a first broadcast TWT schedule on the first link that is aligned with a second broadcast TWT schedule on a second link. The non-AP MLD is associated with an AP MLD. The first link is established between the first STA affiliated with the non-AP MLD and a first AP affiliated with the AP MLD, while the second link is established between a second STA affiliated with the non-AP MLD and a second AP affiliated with the AP MLD.

In operation 1003, the first STA receives a beacon frame or a probe response frame on the first link from the first AP affiliated with the AP MLD.

In operation 1005, the first STA checks the beacon frame or the probe response frame and identifies that there is a broadcast TWT schedule advertised on the first link that is aligned with the second broadcast TWT schedule on the second link. In some embodiments, the first STA checks a broadcast TWT parameter set field included within a broadcast TWT element included in the beacon frame or the probe response frame. The broadcast TWT parameter set field indicates whether there is a broadcast TWT schedule advertised on the first link that is aligned with the second broadcast TWT schedule on the second link.

In some embodiments, a non-AP MLD is associated with an AP MLD and operating on two links, a first link and a second link. A first STA affiliated with the non-AP MLD and operating on the first link intends to establish a first broadcast TWT schedule on the first link that is aligned with a second broadcast TWT schedule on the second link on which a second STA affiliated with the non-AP MLD is operating. When the first STA has been in doze state, the first STA can wake up to receive a beacon frame on the first link to identify whether the first AP affiliated with the AP MLD and operating on the first link is advertising a TWT schedule on the first link that is aligned with the second TWT schedule on the second link.

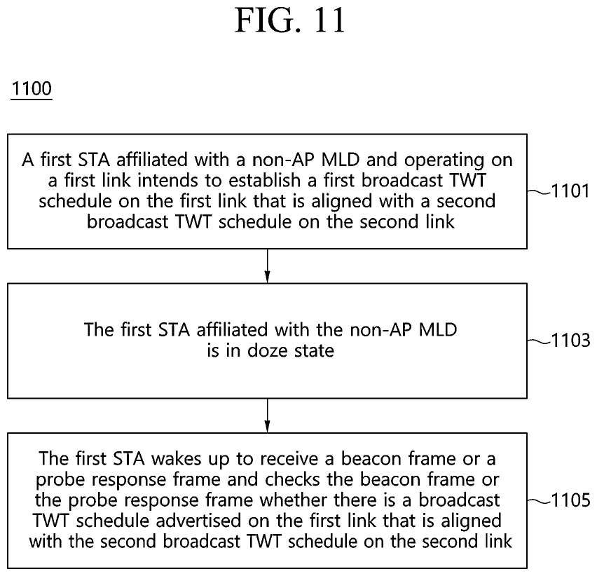

FIG. 11 shows another example process for identifying the presence of aligned TWT schedule in accordance with an embodiment. For explanatory and illustration purposes, the example process 1100 may be performed by the STA 1 depicted in FIGS. 3 and 8. Although one or more operations are described or shown in particular sequential order, in other embodiments the operations may be rearranged in a different order, which may include performance of multiple operations in at least partially overlapping time periods.

The process 1100 may begin in operation 1101. In operation 1101, a first STA affiliated with a non-AP MLD and operating on a first link intends to establish a first broadcast TWT schedule on the first link that is aligned with a second broadcast TWT schedule on a second link. The non-AP MLD is associated with an AP MLD. The first link is established between the first STA affiliated with the non-AP MLD and a first AP affiliated with the AP MLD, while the second link is established between a second STA affiliated with the non-AP MLD and a second AP affiliated with the AP MLD.

In operation 1103, the first STA affiliated with the non-AP MLD is in doze state for power saving.

In operation 1105, the first STA wakes up to receive a beacon frame or a probe response frame on the first link from the first AP affiliated with the AP MLD. The first STA checks the beacon frame or the probe response frame and identifies that there is a broadcast TWT schedule advertised on the first link that is aligned with the second broadcast TWT schedule on the second link. In some embodiments, the first STA checks a broadcast TWT parameter set field included within a broadcast TWT element included in the beacon frame or the probe response frame. The broadcast TWT parameter set field indicates whether there is a broadcast TWT schedule advertised on the first link that is aligned with the second broadcast TWT schedule on the second link. If there is no broadcast TWT schedule aligned with the second broadcast TWT schedule on the second link, the first STA goes back to the doze state after receiving the beacon frame or the probe response frame.

In some embodiments, a non-AP MLD is associated with an AP MLD and operating on two links, a first link and a second link. The first link is established between a first STA affiliated with the non-AP MLD and a second AP affiliated with the AP MLD, while the second link is established between a second STA affiliated with the non-AP and a second AP affiliated with the AP MLD. A first STA intends to establish a broadcast TWT schedule on the first link that is aligned with a second broadcast TWT schedule on the second link. When the first STA observes that there is such a broadcast TWT schedule advertised on the first link that is aligned with the second broadcast TWT schedule on the second link, the first STA may request to establish membership in the aligned broadcast TWT schedule on the first link by sending a TWT request to the first AP affiliated with the AP MLD.

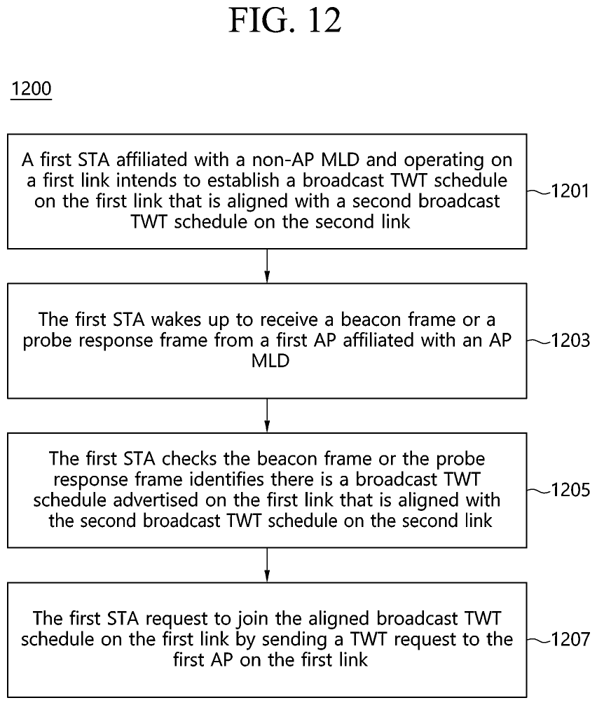

FIG. 12 shows another example process for identifying the presence of an aligned TWT schedule in accordance with an embodiment. For explanatory and illustration purposes, the example process 1200 may be performed by the STA 1 depicted in FIGS. 3 and 8. Although one or more operations are described or shown in particular sequential order, in other embodiments the operations may be rearranged in a different order, which may include performance of multiple operations in at least partially overlapping time periods.

The process 1200 may begin in operation 1201. In operation 1201, a first STA affiliated with a non-AP MLD and operating on a first link intends to establish a broadcast TWT schedule on the first link that is aligned with a second broadcast TWT schedule on a second link. The non-AP MLD is associated with an AP MLD. The first link is established between the first STA affiliated with the non-AP MLD and a first AP affiliated with the AP MLD, while the second link is established between a second STA affiliated with the non-AP MLD and a second AP affiliated with the AP MLD.

In operation 1203, the first STA affiliated with the non-AP MLD receives a beacon frame or a probe response frame from the first AP affiliated with the AP MLD via the first link.

In operation 1205, the first STA checks the beacon frame or the probe response frame and identifies that there is a broadcast TWT schedule advertised on the first link that is aligned with the second broadcast TWT schedule on the second link.

In operation 1207, the first STA requests to join the aligned broadcast TWT schedule or establish membership in the aligned broadcast TWT schedule on the first link by sending a TWT request to the first AP on the first link.

In some embodiments, when an AP MLD intends to offer membership to an aligned broadcast TWT schedule on a first link and a second link, a first AP affiliated with the AP MLD and operating on the first link may advertise the aligned TWT schedule on the first link, and a second AP affiliated with the AP MLD and operating on the second link may advertise the aligned TWT schedule on the second link.

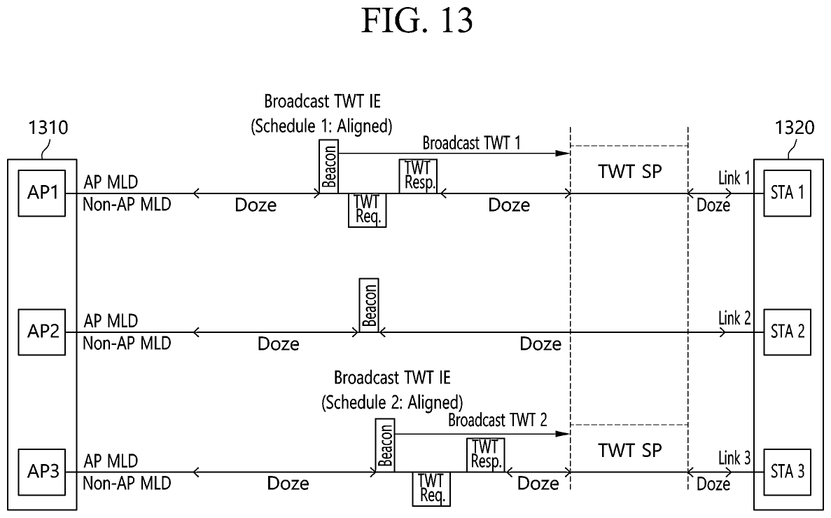

FIG. 13 shows an example of aligned broadcast TWT schedule operation in accordance with an embodiment. The scenario and operations depicted in FIG. 13 are for illustration purposes and do not limit the scope of this disclosure to any particular implementations.

In the example of FIG. 13, an AP MLD 1310 includes three affiliated APs (AP 1, AP 2, and AP 3). AP 1 operates on Link 1, AP 2 operates on Link 2, and AP 3 operates on Link 3. A non-AP MLD 1320 includes three affiliated non-AP STAs (STA 1, STA 2, and STA 3). STA 1 operates on Link 1, STA 2 operates on Link 2, and STA 3 operates on Link. 3. Link 1 is established between AP 1 and STA 1, Link 2 between AP 2 and STA 2, and Link 3 between AP 3 and STA 3.

Referring to FIG. 13, during the initial portion of the illustration, all three non-AP STAs affiliated with the non-AP MLD 1320 are in doze state. At some point in time, STA 1 wakes up to receive a beacon frame on Link 1 and observes that AP 1 is advertising a broadcast TWT schedule (“Schedule-1”) on Link 1. AP 1 indicates in the beacon frame that Schedule-1 is an aligned schedule. STA 1 sends a TWT request to AP 1 requesting to join Schedule-1, and AP 1 accepts the request by sending a TWT response.

Both STA 2 and STA 3 intend to establish broadcast TWT schedules on Link 2 and Link 3, respectively, that are aligned with Schedule-1 on Link 1. Accordingly, both STA 2 and STA 3 wake up to receive beacon frames on Link 2 and Link 3, respectively, to identify the presence of such broadcast TWT schedule, on the corresponding links, that are aligned with Schedule-1 on Link 1. STA 2 observes that there is no broadcast TWT schedule advertised on Link 2 that is aligned with Schedule-1 on Link 1 and goes back to doze state after receiving the beacon frame. STA 3 observes that there is a broadcast TWT schedule (“Schedule-2”) advertised on Link 3 that is aligned with Schedule-1 on Link 1 by checking TWT parameters of the Schedule-2. STA 3 sends a TWT request to AP 3 to join the Schedule-2 on Link 3 and AP 3 accepts the request by sending a TWT response.

In some embodiments, a first AP and a second AP are affiliated with an AP MLD and operating on a first link and a second link respectively. The first link is established between the first AP and a first STA affiliated with a non-AP MLD, while the second link is established between the second AP and a second STA affiliated with the non-AP MLD. When the first AP and the second AP are advertised two broadcast TWT schedules, Schedule-1 and Schedule-2, on the first link and the second link, respectively, that the Schedule-1 and Schedule-2 are aligned to each other, the broadcast TWT ID of the Schedule-1 may be the same as the broadcast TWT ID of the Schedule-2. In some implementations, the broadcast TWT ID of the Schedule-1 may be different from the broadcast TWT ID of the Schedule-2.

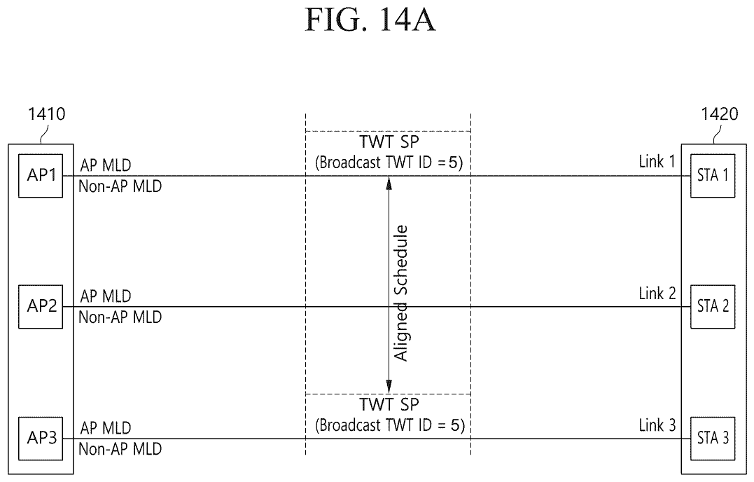

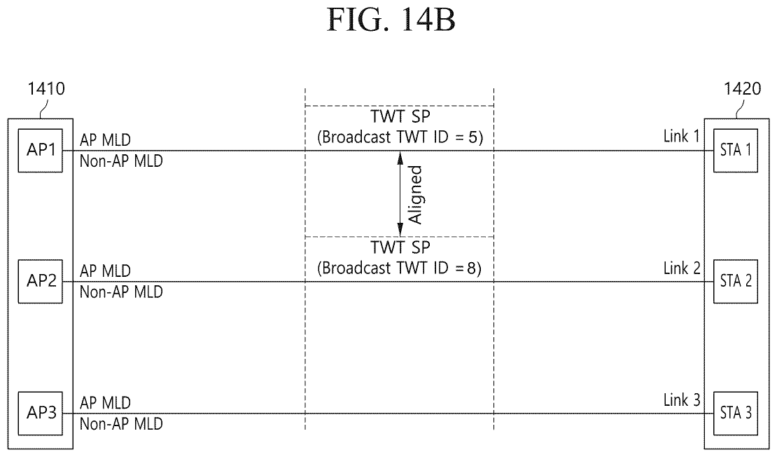

FIGS. 14A and 14B show other examples of aligned broadcast TWT schedule operation in accordance with an embodiment. The scenario and operations depicted in FIGS. 14A and 14B are for illustration purposes and do not limit the scope of this disclosure to any particular implementations.

In the examples of FIGS. 14A and 14B, an AP MLD 1410 includes three affiliated APs (AP 1, AP 2, and AP 3). AP 1 operates on Link 1, AP 2 operates on Link 2, and AP 3 operates on Link 3. A non-AP MLD 1420 includes three affiliated non-AP STAs (STA 1, STA 2, and STA 3). STA 1 operates on Link 1, STA 2 operates on Link 2, and STA 3 operates on Link. 3. Link 1 is established between AP 1 and STA 1, Link 2 between AP 2 and STA 2, and Link 3 between AP 3 and STA 3.

Referring to FIG. 14A, a first broadcast TWT schedule established on Link 1 is aligned with a second broadcast TWT schedule established on Link 3. In this example, a broadcast TWT ID (e.g., Broadcast TWT ID=5) of the first broadcast TWT schedule on Link 1 is the same as a broadcast TWT ID (e.g., Broadcast TWT ID=5) of the second broadcast TWT schedule on Link 3.

Referring to FIG. 14B, a first broadcast TWT schedule established on Link 1 is aligned with a second broadcast TWT schedule established on Link 2. In this example, the broadcast TWT ID (e.g., Broadcast TWT ID=5) of the first broadcast TWT schedule on Link 1 is different from the broadcast TWT ID (e.g., Broadcast TWT ID=8) of the second broadcast TWT schedule on Link 2.

According to some embodiments, the non-AP STAs operating on different links of the non-AP MLD can identify the presence of the aligned TWT schedule advertised by the APs on the corresponding links in the multi-link operation. Additionally, some embodiments provide the power saving operation along with aligned TWT schedules in the multi-link operation.

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the invention. The word exemplary is used to mean serving as an example or illustration. To the extent that the term “include,” “have,” or the like is used, such term is intended to be inclusive in a manner similar to the term “comprise” as “comprise” is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously or may be performed as a part of one or more other steps, operations, or processes. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems can generally be integrated together in a single software/hardware product or packaged into multiple software/hardware products.

The disclosure is provided to enable any person skilled in the art to practice the various aspects described herein. In some instances, well-known structures and components are shown in block diagram form in order to avoid obscuring the concepts of the subject technology. The disclosure provides various examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using a phrase means for or, in the case of a method claim, the element is recited using the phrase step for.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. This method of disclosure is not to be interpreted as reflecting an intention that the claimed subject matter requires more features than are expressly recited in each claim. Rather, as the following claims reflect, inventive subject matter lies in less than all features of a single disclosed configuration or operation. The following claims are hereby incorporated into the detailed description, with each claim standing on its own as a separately claimed subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. A non-access point (AP) multi-link device (MLD) associated with an AP MLD in a wireless network, the non-AP MLD comprising:
at least two stations (STAs), each STA being affiliated with the non-AP MLD; and
a processor coupled to the at least two STAs, the processor configured to cause:
receiving, by a first STA affiliated with the non-AP MLD from a first AP affiliated with the AP MLD via a first link between the first STA and the first AP, a first broadcast frame that advertises a first broadcast target wake time (TWT) schedule and indicates whether the first broadcast TWT schedule is an aligned schedule;
determining, by the first STA, that the first broadcast TWT schedule is aligned with one or more broadcast TWT schedules on one or more of other links of the AP MLD based on the first broadcast frame;
transmitting, by the first STA to the first AP via the first link, a TWT request to join the first broadcast TWT schedule; and
receiving, by the first STA from the first AP via the first link, a TWT response indicating acceptance of the TWT request.

2. The non-AP MLD of claim 1, wherein the processor is further configured to cause:
receiving, by a second STA affiliated with the non-AP MLD from a second AP affiliated with the AP MLD via a second link between the second STA and the second AP, a second broadcast frame advertising a second broadcast TWT schedule;
determining, by the second STA, that there is a second broadcast TWT schedule advertised on the second link that is aligned with the first broadcast TWT schedule on the first link, based on the second broadcast frame;
transmitting, by the second STA to the second AP via the second link, a TWT request to join the second broadcast TWT schedule; and
receiving, by the second STA from the second AP via the second link, a TWT response indicating acceptance of the TWT request to join the second broadcast TWT schedule.

3. The non-AP MLD of claim 1, wherein the processor is further configured to cause:
waking up from doze state to receive, by a third STA affiliated with the non-AP MLD from a third AP affiliated with the AP MLD via a third link between the third STA and the third AP, a third broadcast frame;
determining, by the third STA, that there is no broadcast TWT schedule advertised on the third link that is aligned with the first broadcast TWT schedule on the first link based on the third broadcast frame; and
going back to the doze state after receiving the third broadcast frame.

4. The non-AP MLD of claim 1, wherein the first broadcast frame includes a first TWT element, and the determining comprises checking one or more TWT parameters included in the first TWT element.

5. The non-AP MLD of claim 2, wherein the second broadcast frame includes a second TWT element, and the determining comprises checking one or more TWT parameters included in the second TWT element.

6. The non-AP MLD of claim 3, wherein the third broadcast frame includes a third TWT element, and the determining comprises checking one or more TWT parameters included in the third TWT element.

7. The non-AP MLD of claim 1, wherein the first STA is in doze state, and the receiving comprises waking up to receive the first broadcast frame.

8. The non-AP MLD of claim 2, wherein the second STA is in doze state, and the receiving comprises waking up to receive the second broadcast frame.

9. The non-AP MLD of claim 2, wherein a broadcast TWT identifier of the first broadcast TWT schedule is identical to a broadcast TWT identifier of the second broadcast TWT schedule.

10. An access point (AP) multi-link device (MLD) associated with a non-AP MLD in a wireless network, the AP MLD comprising:
at least two APs, each AP being affiliated with the AP MLD; and
a processor coupled to the at least two APs, the processor configured to cause:
transmitting, by a first AP affiliated with the AP MLD to a first STA affiliated with the non-AP MLD via a first link between the first AP and the first STA, a first broadcast frame that advertises a first broadcast target wake time (TWT) schedule and indicates that the first broadcast TWT schedule is an aligned schedule;
receiving, by the first AP from the first STA via the first link, a TWT request to join the first broadcast TWT schedule; and
transmitting, by the first AP to the first STA via the first link, a TWT response indicating acceptance of the TWT request.

11. The AP MLD of claim 10, wherein the processor is further configured to cause:
transmitting, by a second AP affiliated with the AP MLD to a second STA affiliated with the non-AP MLD via a second link between the second AP and the second STA, a second broadcast frame that advertises a second broadcast TWT schedule and indicates that there is a second broadcast TWT schedule advertised on the second link that is aligned with the first broadcast TWT schedule on the first link;
receiving, by the second AP from the second STA via the second link, a TWT request to join the second broadcast TWT schedule; and
transmitting, by the second AP to the second STA via the second link, a TWT response indicating acceptance of the TWT request to join the second broadcast TWT schedule.

12. The AP MLD of claim 10, wherein the processor is further configured to cause:
transmitting, by a third AP affiliated with the AP MLD to a third STA affiliated with the non-AP MLD via a third link between the third AP and the third STA, a third broadcast frame indicating that there is no broadcast TWT schedule advertised on the third link that is aligned with the first broadcast TWT schedule on the first link.

13. The AP MLD of claim 10, wherein the first broadcast frame includes a first TWT element, and one or more TWT parameters included in the first TWT element indicate that the first broadcast TWT schedule is aligned with one or more broadcast TWT schedules on one or more of other links of the AP MLD.

14. The AP MLD of claim 11, wherein the second broadcast frame includes a second TWT element, and one or more TWT parameters included in the second TWT element indicate that the second broadcast TWT schedule is aligned with the first broadcast TWT schedule on the first link.

15. The AP MLD of claim 12, wherein the third broadcast frame includes a third TWT element, and one or more TWT parameters included in the third TWT element indicate that there is no broadcast TWT schedule advertised on the third link that is aligned with the first broadcast TWT schedule on the first link.

16. The AP MLD of claim 11, wherein a broadcast TWT identifier of the first broadcast TWT schedule is identical to a broadcast TWT identifier of the second broadcast TWT schedule.

17. A computer-implemented method for facilitating wireless communication, the method comprising:
receiving, by a first station (STA) affiliated with a non-access point (AP) multi-link device (MLD) from a first AP affiliated with an AP MLD associated with the non-AP MLD on a first link between the first STA and the first AP, a first broadcast frame advertising a first broadcast target wake time (TWT) schedule on the first link;
determining that the first broadcast TWT schedule is aligned with one or more broadcast TWT schedules on one or more of other links of the AP MLD based on the first broadcast frame;
transmitting, by the first STA to the first AP on the first link, a TWT request to join the first broadcast TWT schedule on the first link; and
receiving, by the first STA from the first AP on the first link, a TWT response to accept the TWT request.

18. The computer-implemented method of claim 17, further comprising:
receiving, by a second STA affiliated with the non-AP MLD from the second AP affiliated with the AP MLD on a second link between the second STA and the second AP, a second broadcast frame advertising a second broadcast TWT schedule on the second link;
determining, by the second STA, that the second broadcast TWT schedule is aligned with the first broadcast TWT schedule on the first link based on the second broadcast frame;
transmitting, by the second STA to the second AP on the second link, a TWT request to join the second broadcast TWT schedule on the second link; and
receiving, by the second STA from the second AP on the second link, a TWT response indicating acceptance of the TWT request to join the second broadcast TWT schedule on the second link.

19. The computer-implemented method of claim 17, further comprising:
waking up from doze state to receive, by a third STA affiliated with the non-AP MLD from a third AP affiliated with the AP MLD on a third link between the third STA and the third AP, a third broadcast frame advertising a broadcast TWT schedule;
determining, by the third STA, that there is no broadcasting TWT schedule advertised on the third link that is aligned with the first broadcast TWT schedule based on the third broadcast frame; and
going back to the doze state after receiving the third broadcast frame.

20. The computer-implemented method of claim 18, wherein a broadcast TWT identifier of the first broadcast TWT schedule is identical to a broadcast TWT identifier of the second broadcast TWT schedule.
